(19) United States
(12) Patent Application Publication
(10) Pub. No.: US 2016/0253257 A1
(43) Pub. Date: Sep. 1, 2016

(54) DATA PROCESSING SYSTEM AND OPERATING METHOD THEREOF

(71) Applicant: SK hynix Inc., Gyeonggi-do (KR)

(72) Inventors: Ki Duck KIM, Gyeonggi-do (KR); Eu Joon BYUN, Gyeonggi-do (KR); Duk Rae LEE, Gyeonggi-do (KR); Seung Ho CHOI, Gyeonggi-do (KR)

(21) Appl. No.: 14/732,436

(22) Filed: Jun. 5, 2015

(30) Foreign Application Priority Data
Feb. 27, 2015 (KR) 10-2015-0028328

(51) Int. Cl. G06F 12/02; G06F 3/06

(52) U.S. Cl. CPC G06F 12/0253; G06F 3/0608; G06F 3/0644; G06F 3/0647; G06F 3/0673; G06F 2212/1044

(57) ABSTRACT

A data processing system includes a host device suitable for assigning a context identifier to data based on attribute information of the data, and a data storage device suitable for performing a garbage collection operation based on the context identifier.

### CROSS-REFERENCES TO RELATED APPLICATION

The present application claims priority under 35 U.S.C. §119(a) to Korean application number 10-2015-0028328 filed on Feb. 27, 2015, which is incorporated herein by reference in its entirety.

### BACKGROUND

1. Technical Field

Various embodiments relate to a data processing system and, more particularly, to a data storage device and an operating method thereof.

2. Related Art

Data processing systems are included in electronic devices, such as a desktop computer, a laptop computer, a smart phone, an MP3 player, a personal digital assistants (PDA), a portable multimedia player (PMP), a digital television, a digital camera, and a portable game console, for processing audio and video data. Data processing systems may include a data storage device for storing data.

The data storage devices may include a nonvolatile memory device in which stored data may be retained even when power is lost. The nonvolatile memory devices may include a flash memory, such as an NAND flash memory or an NOR flash memory, a ferroelectrics random access memory (FeRAM), a phase-change random access memory (PCRAM), a magnetoresistive random access memory (MRAM), a resistive random access memory (ReRAM), or the like.

### SUMMARY

In an embodiment of the present invention, a data processing system may include: a host device suitable for assigning a context identifier to data based on attribute information of the data; and a data storage device suitable for performing a garbage collection operation based on the assigned context identifier.

In an embodiment of the present invention, a data processing system includes: a host device suitable for classifying attribute information of data to select one of a plurality of context identifiers; and a data storage device suitable for selecting a memory region, in which the data is to be stored, based on the selected context identifier.

In an embodiment of the present invention, an operating method of a data processing system may include: assigning a context identifier to data based on attribute information of the data; and storing the data for processing a write request; and performing a garbage collection operation based on the assigned context identifier.

### BRIEF DESCRIPTION OF THE DRAWINGS

Features, aspects, and embodiments are described in conjunction with the attached drawings, in which:

FIG. 1 is a block diagram illustrating a data processing system in accordance with an embodiment of the present invention;

FIG. 2 is a detailed diagram of a data storage device shown in FIG. 1;

FIGS. 3A and 3B are tables exemplarily showing memory blocks corresponding to context identifiers;

FIGS. 4 to 6 are illustrations for describing the operations of the data storage device shown in FIG. 1;

FIG. 7 is a flowchart for describing an operation of a host device shown in FIG. 1; and

FIG. 8 is a flowchart for describing an operation of the data storage device shown in FIG. 1.

### DETAILED DESCRIPTION

Hereinafter, a data processing system and an operating method thereof according to the present invention will be described with reference to the accompanying drawings through exemplary embodiments of the present invention. The present invention may, however, be embodied in different forms and should not be construed as being limited to the embodiments set forth herein. Rather, these embodiments are provided to describe the present invention in detail to the extent that a person skilled in the art to which the invention pertains can enforce the technical concepts of the present invention.

It is to be understood that embodiments of the present invention are not limited to the particulars shown in the drawings, that the drawings are not necessarily to scale, and, in some instances, proportions may have been exaggerated to more clearly depict certain features of the invention. While particular terminology is used, it is to be appreciated that the terminology used is for describing particular embodiments only and is not intended to limit the scope of the present invention.

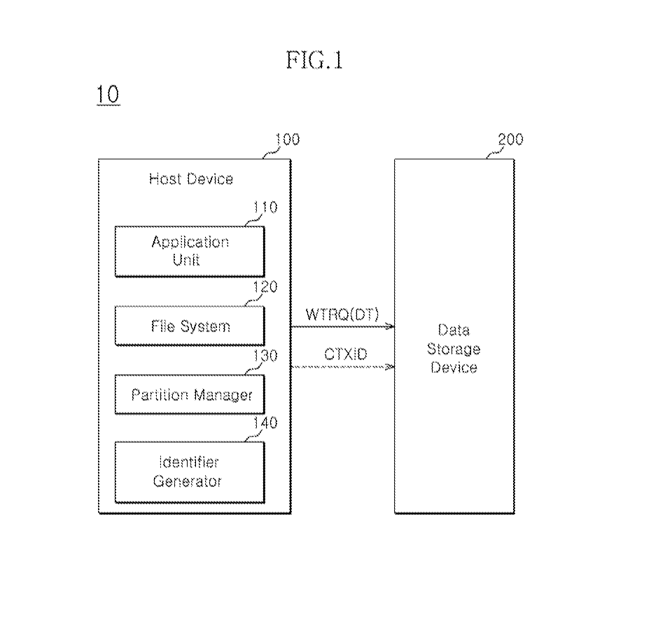

FIG. 1 is a block diagram illustrating a data processing system 10 in accordance with an embodiment of the present invention.

The data processing system 10 may include a host device 100 and a data storage device 200.

The host device 100 may include an application unit 110, a file system 120, a partition manager 130, and an identifier generator 140.

The application unit 110 may be software executed on an operating system, and may be designed to perform a specific task, for example, a document work, an image reproduction, or the like. The application unit 110 may generate, change or delete a file in the data storage device 200 when performing an assigned task. To generate, change or delete a file, the application unit 110 may transmit commands to the file system 120.

The file system 120 may manage files processed in the data processing system 10. For example, the file system 120 may systematize files stored in the data storage device 200 by setting names and assigning positions for the files under predefined rules, in response to a command of the application unit 110.

The file system 120 may provide the identifier generator 140 with a file, i.e., attribute information of data, to be stored in the data storage device 200. For example, when certain data is stored in the data storage device 200, the file system 120 may determine the attributes of the corresponding data, and provide the identifier generator 140 with the determined attributes as the attribute information. The attribute information to be provided by the file system 120 may include, for example, information on the type of data, such as multimedia data, metadata, swap data, journal data, or the like. Furthermore, the attribute information may indicate various characteristics of data, such as the size of data and an update frequency.

The partition manager 130 may manage partition information of the data storage device 200. The partition manager 130 may provide the identifier generator 140 with attribute information of data to be stored in the data storage device 200. The partition manager 130 may provide the identifier generator 140, for example, with information on a partition in which data is to be stored, as the attribute information.

On the basis of the attribute information of data provided from the file system 120 and/or the partition manager 130, the identifier generator 140 may generate a context identifier corresponding to the data. The identifier generator 140 may classify attribute information of data, and select a context identifier corresponding to relevant data among a plurality of context identifiers. For example, the identifier generator 140 may generate a first context identifier for a file to be stored in a first drive and generate a second context identifier for a file to be stored in a second drive by referring to attribute information provided from the partition manager 130. For example, the identifier generator 140 may generate a first context identifier for multimedia data and generate a second context identifier for metadata by referring to attribute information provided from the partition manager 130. The generated context identifiers are assigned to corresponding data. Pieces of data to which the same context identifier is assigned may have mutually similar attributes.

When transmitting a write request WTRQ of data DT to the data storage device 200, the host device 100 may transmit a context identifier CTXID assigned to the data DT, together with the write request WTRQ, to the data storage device 200 by adding or including the context identifier CTXID in the write request WTRQ.

The data storage device 200 may receive a write request WTRQ of data DT and a context identifier CTXID from the host device 100, and store the data on the basis of the context identifier CTXID. In addition, to continuously manage data according to a context identifier CTXID, the data storage device 200 may store the context identifier CTXID in a nonvolatile memory device 220.

Specifically, the data storage device 200 may assign corresponding memory regions, which are mutually different, to the respective context identifiers, to be provided from the host device 100, and may store write-requested data in a memory region corresponding to a context identifier given to the data. The data storage device 200 may further efficiently operate memory regions by classifying and collectively storing data having a similar attribute, on the basis of an equal context identifier, in a predetermined memory region.

Specifically, pieces of data having similar attributes may be generally similar to each other in an update frequency. Updating data is accompanied with a process of invalidating data before the updating. Therefore, when pieces of data having mutually similar update frequencies are stored together in predetermined memory regions, memory regions may have a large deviation in their degree of invalidation. For example, when pieces of data having a first attribute have a relatively high update frequency, a memory region in which pieces of data having the first attribute are classified and stored may have a relatively high invalidation degree. For example, when pieces of data having a second attribute have a relatively low update frequency, a memory region in which pieces of data having the second attribute are classified and stored may have a relatively low invalidation degree. In addition, this may be supported even by the principle of locality. Accordingly, when memory blocks are managed to have a large deviation in degree of invalidation, the data storage device 200 may easily select a victim region on a garbage collection operation by selecting a memory region having a high invalidation degree as the victim region. In addition, since the selected victim region has a high invalidation degree, i.e., does not include much valid data, the data storage device 200 may save a valid data copy cost on a garbage collection operation.

The data storage device 200 may form a personal computer memory card international association (PCMCIA) card, a compact flash (CF) card, a smart media card, a memory stick, a multimedia card (MMC), an embedded MMC (eMMC), a reduced-size multimedia card (RS-MMC) and a micro-size version of MMC (MMC-micro), a secure digital (SD) card, a mini secure digital (mini-SD) and a micro secure digital (micro-SD), a universal flash storage (UFS), or a solid-state drive (SSD).

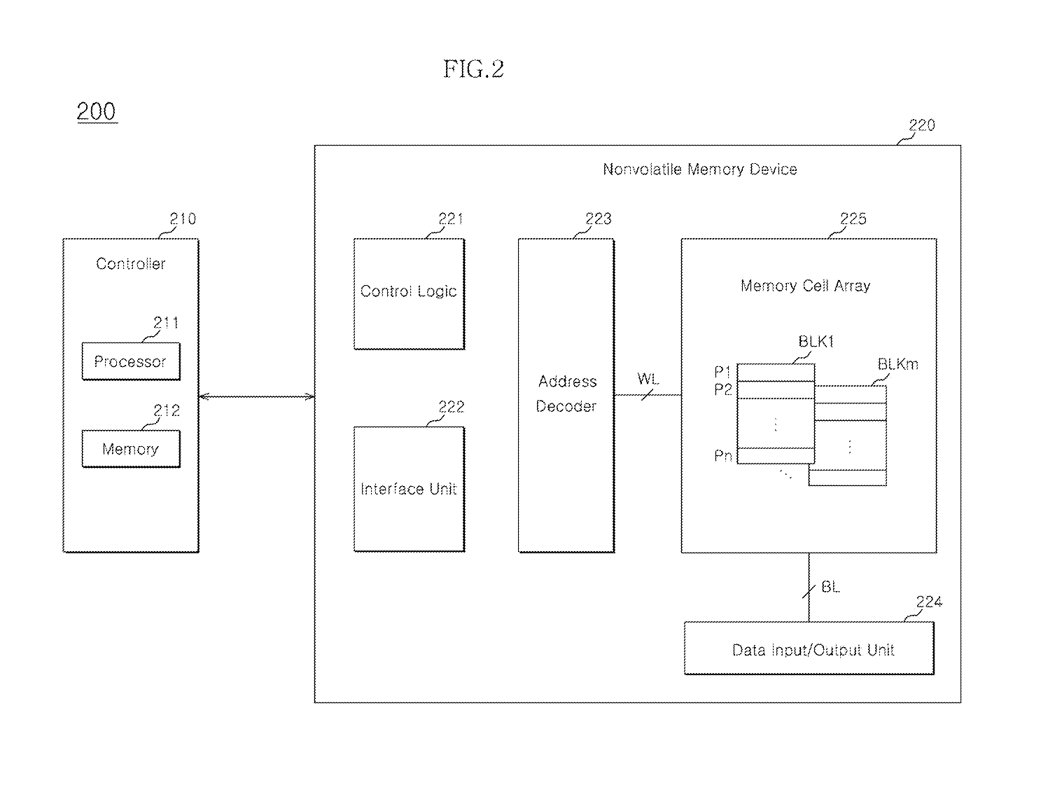

FIG. 2 is a detailed diagram of the data storage device 200 shown in FIG. 1.

The data storage device 200 may include a controller 210 and a nonvolatile memory device 220.

The controller 210 may include a processor 211 and a memory 212.

The processor 211 may control the entire operations of the data storage device 200. The processor 211 may control the write operation or read operation of the nonvolatile memory device 220 through a command in response to a write request or a read request from the host device 100. The processor 211 may drive a software program, on the memory 212, for controlling the operation of the data storage device 200.

The processor 211 may map a logical address, which is provided when receiving a write request from the host device 100, to a physical address on the nonvolatile memory device 220. The processor 211 may determine a memory region, in which write-requested data is to be stored, according to a context identifier assigned to the data, and map a physical address of the determined memory region to a logical address provided from the host device 100. The processor 211 may manage physical addresses mapped to logical addresses with a mapping table.

The memory 212 may function as an operation memory of the processor 211, a buffer memory of the processor 211, a cache memory of the processor 211, or the like.

The nonvolatile memory device 220 may include a control logic 221, an interface unit 222, an address decoder 223, a data input/output unit 224, and a memory cell array 225.

The control logic 221 may control the general operations, such as a write operation, a read operation, and an erase operation, of the nonvolatile memory device 220 in response to a command provided from the controller 210.

The interface unit 222 may transmit and receive data and various control signals, including commands and addresses, to and from the controller 210. The interface unit 222 may transfer received data and various control signals to the internal units of the nonvolatile memory device 220.

The address decoder 223 may decode transmitted row addresses and column addresses. The address decoder 223 may control word lines WL to be selectively driven according to a decoding result of a row address. The address decoder 223 may control the data input/output unit 224 to selectively drive bit lines BL according to a decoding result of a column address.

The data input/output unit 224 may transmit data, which is transmitted from the interface unit 222, to the memory cell array 225 via bit lines BL. The data input/output unit 224 may transmit data, which is read from the memory cell array 225 via bit lines BL, to the interface unit 222.

The memory cell array 225 may be electrically coupled to the address decoder 223 via word lines WL, and may be electrically coupled to the data input/output unit 224 via bit lines BL. The memory cell array 225 may be implemented, for example, in a three-dimensional structure. The memory cell array 225 may include a plurality of memory cells which are respectively disposed at intersecting points of word lines WL and bit lines BL.

The memory cell array 225 may include a plurality of memory blocks BLK1 to BLKm. Each of the memory blocks BLK1 to BLKm may include a plurality of pages (e.g., P1 to Pn). The memory block may be a unit in which an erase operation is performed. The page may be a unit in which a write operation or a read operation is performed.

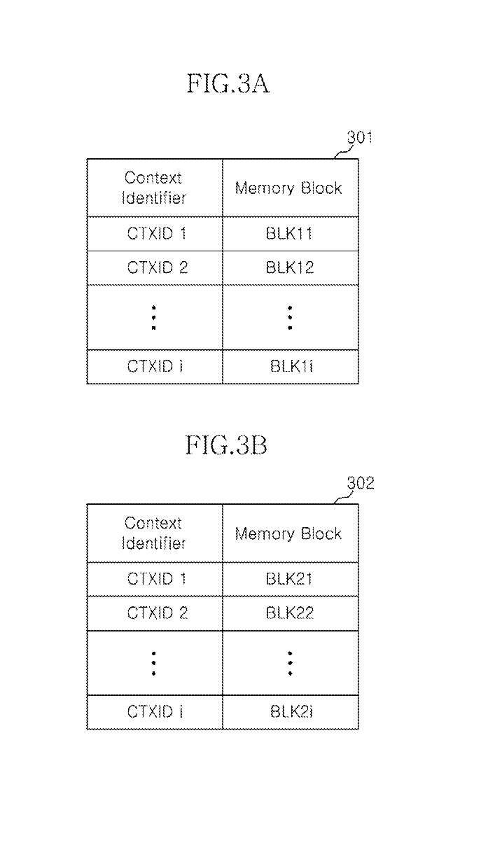

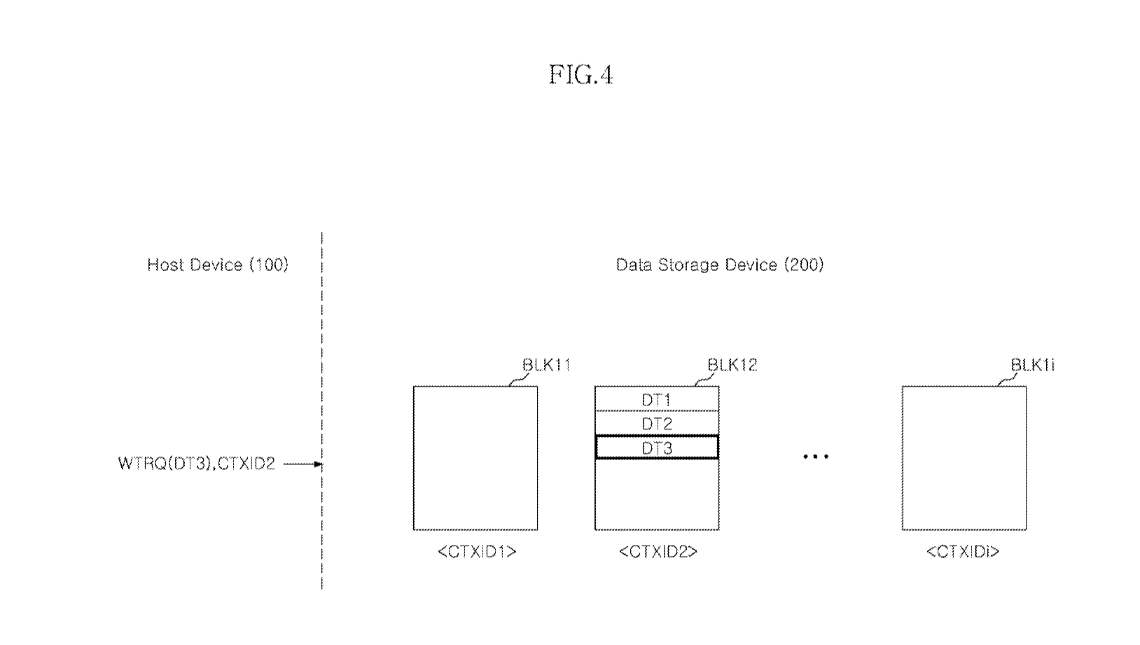

FIGS. 3A and 3B are tables exemplarily showing memory blocks BLK11 to BLK1i or BLK21 to BLK2i corresponding to the respective context identifiers CTXID1 to CTXIDi.

The processor 211 may match the respective context identifiers CTXID1 to CTXIDi, which are to be provided from the host device 100, with corresponding memory regions. For example, the processor 211 may match the context identifiers CTXID1 to CTXIDi with memory blocks, respectively. However, unit of a memory region with which the processor 211 matches each of the context identifiers CTXID1 to CTXIDi is not limited to a memory block.

As illustrated in FIG. 3A, a first table 301 shows memory blocks BLK11 to BLK1i with which the processor 211 matches context identifiers CTXID1 to CTXIDi to process a write request of the host device 100. Furthermore, as illustrated in FIG. 3B, a second table 302 shows memory blocks BLK21 to BLK2i with which the processor 211 matches context identifiers CTXID1 to CTXIDi to perform a garbage collection operation.

Referring to the first table 301, the processor 211 may match the memory blocks BLK11 to BLK1i, in which write-requested data is to be stored, with the context identifiers CTXID1 to CTXIDi, respectively. The memory blocks BLK11 to BLK1i corresponding to the context identifiers CTXID1 to CTXIDi, respectively, may be in an open state. When a memory block of the memory blocks has no more empty pages, and thus is closed, the processor 211 may match a new empty memory block with a context identifier corresponding to the closed memory block.

Referring to the second table 302, the processor 211 may match context identifiers CTXID1 to CTXIDi with memory blocks BLK21 to BLK2i, respectively, to which valid data moves on a garbage collection operation.

The processor 211 may simultaneously maintain the memory blocks BLK11 to BLK1i for processing a write request and the memory blocks BLK21 to BLK2i for a garbage collection operation. The processor 211 may maintain the memory blocks BLK11 to BLK1i for processing a write request, or may maintain the memory blocks BLK21 to BLK2i for a garbage collection operation.

Referring again to FIG. 2, the processor 211 may refer to a context identifier assigned to write-requested data, and control the write-requested data to be stored in a memory block corresponding to the referred context identifier to which reference is made. When performing a garbage collection operation, the processor 211 may make reference to a context identifier assigned to valid data of a victim region, and control the valid data to be stored in a memory block corresponding to the context identifier to which reference is made.

FIGS. 4 to 6 are views for describing an operation of the data storage device 200 shown in FIG. 1.

Referring to FIG. 4, the data storage device 200 may prepare memory blocks BLK11 to BLK1i corresponding to context identifiers CTXID1 to CTXIDi, respectively, to process a write request WTRQ. The data storage device 200 may receive a write request WTRQ for data and a context identifier CTXID2 assigned to data DT3 from the host device 100. The data storage device 200 may refer to the context identifier CTXID2 assigned to the write-requested data DT3, and store the corresponding data in a memory block BLK12 corresponding to the referred context identifier CTXID2. The memory block BLK12 may store data DT1 to DT3 to which the context identifier CTXID2 is assigned.

Since pieces of data stored in one memory block have mutually similar attributes, the data storage device 200 may efficiently utilize memory resources at low cost. For example, when the host device 100 assigns a context identifier CTXID2 to journal data and thus a second memory block BLK12 stores only journal data, the second memory block BLK12 may have a high invalidation degree due to the characteristics of journal data that is frequently updated, and may be processed at a low copy cost although the second memory block BLK12 is selected as a victim region on a garbage collection operation. For example, when the host device 100 assigns a context identifier CTXID2 to moving image data and thus a second memory block BLK12 stores only moving image data, the second memory block BLK12 may be not selected as a victim region on a garbage collection operation, due to the characteristics of moving image data that is rarely updated. For example, when the host device 100 assigns a context identifier CTXIDi to metadata and thus an i^{th} memory block BLK1i stores only metadata, the second memory block BLK1i may have a high invalidation degree due to the characteristics of metadata that is frequently updated, and may be processed at a low copy cost although the i^{th} memory block BLK1i is selected as a victim region on a garbage collection operation.

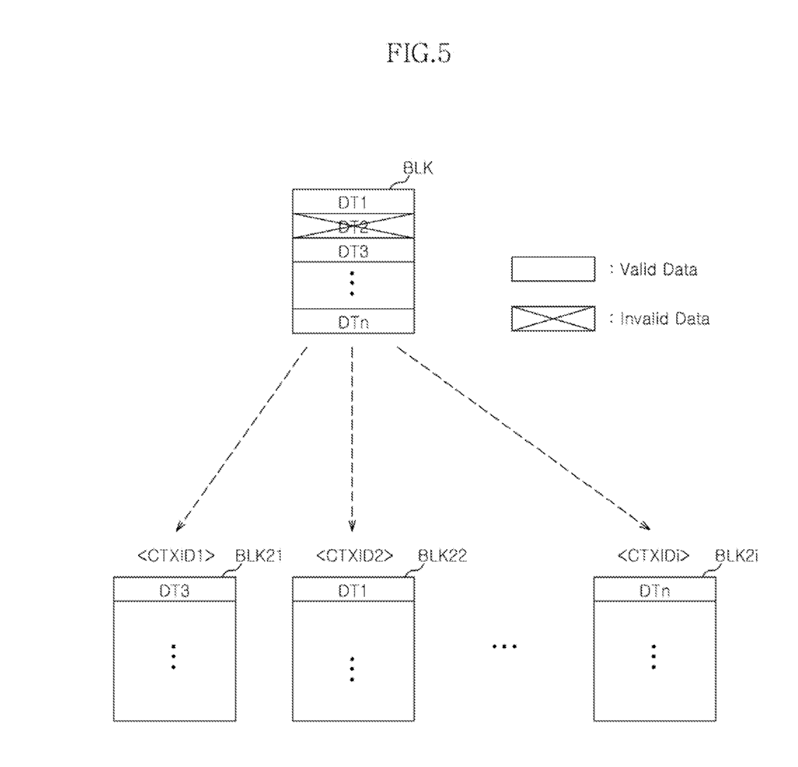

Referring to FIG. 5, the data storage device 200 may store a context identifier, in the nonvolatile memory device 220, which is provided together with a write request for data. For example, when storing write-requested data, the data storage device 200 may store a context identifier in a space region of a page in which the data is stored, or may store the context identifier in a separate memory region allocated for the context identifier. Therefore, with respect to data stored in the nonvolatile memory device 220 according to a write request, the data storage device 200 may determine the attributes of the data by referring to a context identifier whenever necessary.

The data storage device 200 may prepare memory blocks BLK21 to BLK2i corresponding to context identifiers CTXID1 to CTXIDi, respectively, to perform a garbage collection operation. When performing a garbage collection operation, the data storage device 200 may refer to a context identifier assigned to valid data of a victim memory block BLK, and store the valid data in a memory block corresponding to the referred context identifier. For example, when a context identifier CTXID1 is assigned to valid data DT3, the data storage device 200 may store the valid data DT3 in a first memory block BLK21 corresponding to the context identifier CTXID1.

A victim memory block BLK may be in a state where pieces of data to which corresponding context identifiers are assigned are mixed and stored. Even after performing a garbage collection operation, the data storage device 200 may continuously keep the context identifier of valid data in the nonvolatile memory device 220.

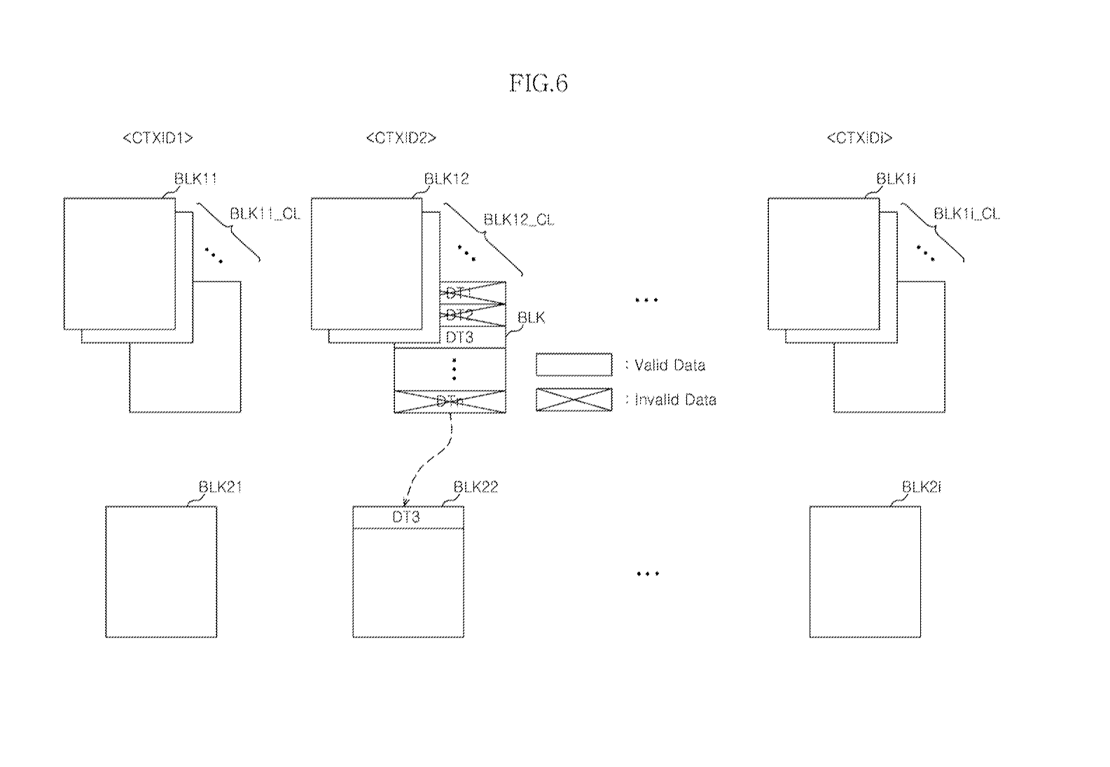

Referring to FIG. 6, the data storage device 200 may prepare memory blocks BLK11 to BLK1i corresponding to context identifiers CTXID1 to CTXIDi, respectively, to process a write request, and may prepare BLK21 to BLK2i corresponding to context identifiers CTXID1 to CTXIDi, respectively, to perform a garbage collection operation.

As described with reference to FIG. 4, the data storage device 200 may store write-requested data in open memory blocks BLK11 to BLK1i according to a context identifier assigned to the data. FIG. 6 additionally illustrates closed memory blocks BLK11_CL-BLK1i_CL which correspond to context identifiers CTXID1 to CTXIDi, respectively, and are filled with data. The data storage device 200 may keep a correspondence state of context identifiers CTXID1 to CTXIDi to the closed memory blocks BLK11_CL-BLK1i_CL for a garbage collection operation.

When performing a garbage collection operation, the data storage device 200 may refer to a context identifier CTXID2 corresponding to a victim memory block (e.g., BLK) or a context identifier assigned to valid data of the victim memory block BLK, and move valid data (e.g., DT3) to a memory block BLK22, which corresponds to the referred context identifier CTXID2, among memory blocks BLK21 to BLK2i open for the garbage collection operation.

That is, the data storage device 200 collects and stores data having similar attributes in a particular region not only when processing a write request but also when performing a garbage collection operation, so that the operating efficiency of memory resources may be maximized.

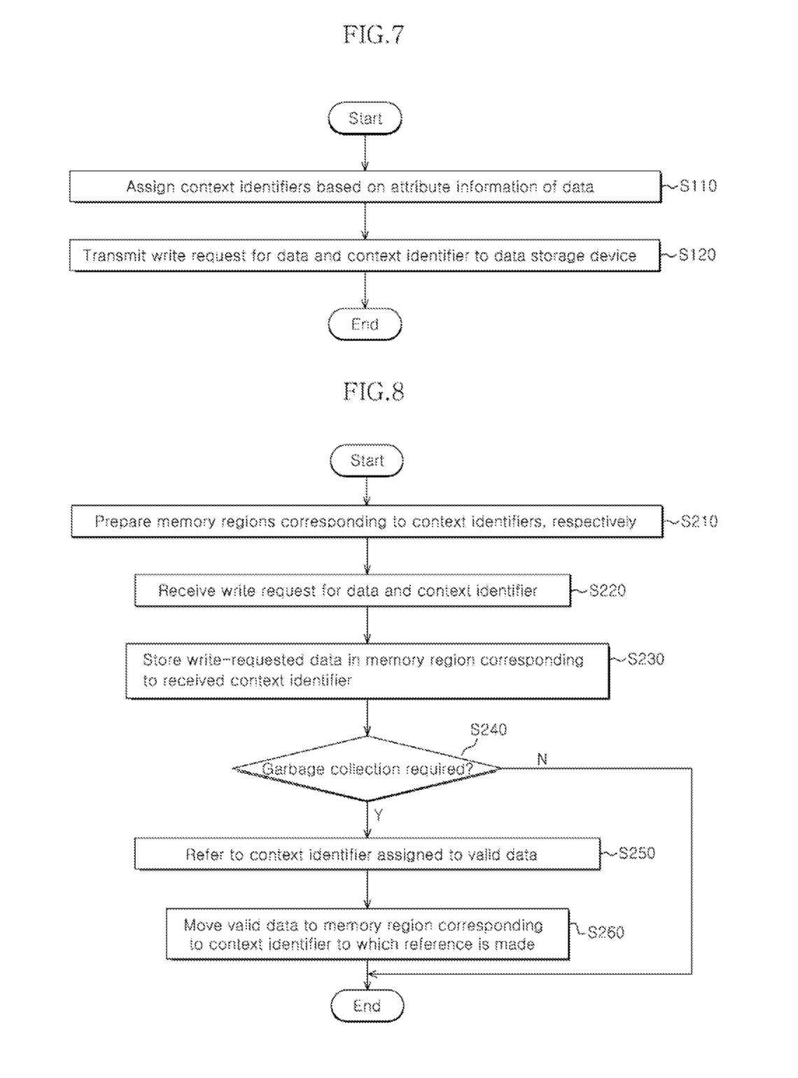

FIG. 7 is a flowchart for describing an operation the host device 100 shown in FIG. 1.

In step S110, the host device 100 may assign a context identifier to data to be stored in the data storage device 200, on the basis of the attribute information of the data. The attribute information of data may include information on the type of data, the size of data, an update frequency, and a partition in which data is to be stored. The host device 100 may assign the same context identifier to pieces of data having a mutually similar attribute. The host device 100 may assign corresponding context identifiers to pieces of data having mutually different attributes, respectively.

In step S120, the host device 100 may transmit a write request for data and a context identifier assigned to the data to the data storage device 200.

FIG. 8 is a flowchart for describing an operation of the data storage device 200 shown in FIG. 1.

In step S210, the data storage device 200 may prepare memory regions corresponding to context identifiers, respectively. The data storage device 200 may prepare memory regions (hereinafter, referred to as a first group) corresponding to context identifiers, respectively, for processing a write request. The data storage device 200 may prepare memory regions (hereinafter, referred to as a second group) corresponding to context identifiers, respectively, for performing a garbage collection operation.

In step S220, the data storage device 200 receives a write request for data and a context identifier assigned to the data from the host device 100.

In step S230, the data storage device 200 may store the write-requested data in a memory region corresponding to the received context identifier. The data storage device 200 may select a memory region corresponding to the received context identifier from the first group to store the write-requested data.

In step S240, the data storage device 200 may determine whether a garbage collection operation is required, for example, during an idle time. The data storage device 200 may determine that a garbage collection operation is required for ensuring an empty memory region. When it is determined that a garbage collection operation is required, the procedure may proceed to step S250. When it is determined that a garbage collection operation is not required, the procedure may be terminated.

In step S250, the data storage device 200 may refer to a context identifier assigned to valid data of a victim memory region.

In step S260, the data storage device 200 may move the valid data to a memory region corresponding to the referred context identifier. To move the valid data, the data storage device 200 may select a memory region corresponding to the context identifier assigned to the valid data from the second group.

While certain embodiments have been described above, it will be understood to those skilled in the art that the embodiments described are examples only. Accordingly, the system and method described herein should not be limited based on the described embodiments. Rather, the system and method described herein should only be limited in light of the claims that follow when taken in conjunction with the above description and accompanying drawings.

What is claimed is:

1. A data processing system comprising:
a host device suitable for assigning a context identifier to data based on attribute information of the data; and
a data storage device suitable for performing a garbage collection operation based on the assigned context identifier.

2. The system according to claim 1, wherein the data storage device matches corresponding memory regions with a plurality of context identifiers, respectively.

3. The system according to claim 2, wherein the data storage device receives a write request for data and a context identifier assigned to the data from the host device, and stores the data in a memory region corresponding to the assigned context identifier based on the write request.

4. The system according to claim 2, wherein when performing the garbage collection operation, the data storage device refers to a context identifier assigned to valid data of a victim memory region, and moves the valid data to a memory region corresponding to the referred context identifier.

5. The system according to claim 1, wherein the host device comprises an identifier generator suitable for classifying attribute information of data to select a context identifier corresponding to the classified attribute information.

6. The system according to claim 5, wherein the host device further comprises a file system suitable for determining an attribute of data to provide the identifier generator with the determined attribute as the attribute information.

7. The system according to claim 5, wherein the host device further comprises a partition manager suitable for providing the identifier generator with information on a partition in which the data is to be stored, as the attribute information.

8. A data processing system comprising:
a host device suitable for classifying attribute information of data to select a corresponding one of a plurality of context identifiers; and
a data storage device suitable for selecting a memory region, in which the data is to be stored, based on the selected context identifier.

9. The system according to claim 8, wherein the data storage device selects the memory region corresponding to the selected context identifier, among a plurality of memory regions corresponding to the respective context identifiers, as the memory region to store the data therein.

10. The system according to claim 8, wherein:
the host device adds the selected context identifier to a write request for the data, and transmits the write request to the data storage device; and
the data storage device selects the memory region to process the write request.

11. The system according to claim 8, wherein, when performing a garbage collection operation, the data storage device selects the memory region, and moves the data from a victim memory region to the selected memory region.

12. The system according to claim 8, wherein the host device comprises an identifier generator suitable for classifying the attribute information of the data to select the corresponding context identifier; and
a file system suitable for determining an attribute of data to provide the identifier generator with the determined attribute as the attribute information.

13. The system according to claim 12, wherein the host device further comprises a partition manager suitable for providing the identifier generator with information on a partition in which the data is to be stored, as the attribute information.

14. An operating method of a data processing system, the method comprising:
assigning a context identifier to data based on attribute information of the data;
storing the data for processing a write request; and
performing a garbage collection operation based on the assigned context identifier.

15. The operating method according to claim 14, wherein the data processing system comprises:
a host device suitable for performing the assigning of the context identifier and transmitting the write request for the data and the context identifier; and
a data storage device suitable for performing the storing of the data and the garbage collection operation.

16. The operating method according to claim 15, wherein the data storage device matches context identifiers with corresponding memory regions included in the data storage device, respectively.

17. The operating method according to claim 16, wherein the storing of the data comprises:
selecting a memory region corresponding to the context identifier; and
storing the data in the selected memory region.

18. The operating method according to claim 16, wherein the performing of the garbage collection operation comprises:
referring to a context identifier assigned to valid data of a victim memory region;
selecting a memory region corresponding to the referred context identifier; and
moving the valid data to the selected memory region.

19. The operating method according to claim 15, wherein the attribute information comprises at least one among a type of data, a size of data, an update frequency, and information on a partition in which data is to be stored.

20. The operating method according to claim 15, further comprising storing the context identifier in a nonvolatile memory device included in the data storage device.
